(19) United States
(12) Patent Application Publication
(10) Pub. No.: US 2014/0164088 A1
(43) Pub. Date: Jun. 12, 2014

(54) SOCIAL NETWORK LOYALTY-REWARD SYSTEM AND METHOD

(71) Applicant: Mark R. Rorabaugh, Centreville, VA (US)

(72) Inventor: Mark R. Rorabaugh, Centreville, VA (US)

(21) Appl. No.: 13/706,952

(22) Filed: Dec. 6, 2012

(51) Int. Cl. G06Q 30/02

(52) U.S. Cl. CPC G06Q 30/0226
USPC 705/14.27

(57) ABSTRACT

A social network loyalty-reward system and method provides an application downloadable to a mobile device. Using the system and a customer's mobile device, the application permits participation in a vendor's loyalty program, the participation being triggered by proximity of the user to a specific location or vendor's site. When the user's presence near a point of sale (POS) or other location is detected, rewards are uploaded to the user's account. Moreover, rewards are distributed to individuals in a contact list or social network of the user's mobile device. This obviates the requirement for a customer to produce a physical card or enter an “ID” number to receive loyalty points. Distribution of loyalty points to the user's social network, as defined by the user's contact list, engenders loyalty to the retailer on the part of the user and his/her social contacts.

This application claims the benefit of U.S. Provisional Application No. 61/567,934, filed Dec. 7, 2011, which is hereby incorporated by reference in its entirety.

### FIELD OF THE INVENTION

The present invention relates to customer loyalty systems, and particularly to a social network loyalty-reward system and method.

### BACKGROUND

Traditional loyalty programs are usually managed by one vendor, and provide rewards to only the current customer. In addition, to participate in a loyalty program, the customer is required to produce a physical card or enter Personally Identifiable Information, such as a telephone number.

Many services simply broadcast discounts or coupons when you are near a particular location, and users are not otherwise rewarded for repeat business. Other systems reward only the repeat customer, but not his friends or relatives.

Thus, a social network loyalty-reward system and method solving the aforementioned problems is desired.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

In a new social network loyalty reward system and method, multiple vendor loyalty programs may be handled by one software application (App) or program called “Groyalty.” The system in combination with a user's mobile device may permit participation in a vendor's loyalty program by detecting the user's presence near a store, cash register, or similar mobile or stationary device with the application, which, in turn, is connected to a Groyalty system (which may be a single server, server cluster, cloud-based system, etc.) through the internet. This obviates the requirement for a customer to produce a physical card or enter an “ID” number to receive loyalty points. This embodiment of a loyalty program requires no action on the user/customer's part. Another embodiment of a loyalty program requires user action, specifically the action of providing a loyalty program card or an “ID” number or similar.

The system is specifically designed and arranged to utilize a user's social network, as defined for example by the user's contact list stored in the user's mobile device, and may provide rewards to those parties, as well as to the user/customer themselves. The contacts may also be harvested from various social networking websites such as Facebook®, Linkedln®, etc. The source used for the contacts may be chosen, in embodiments, by individual vendors or by Groyalty administration, or by the users. Users may provide login information for accounts with one or more social networking websites to permit the Groyalty application to access their contact lists. Users may also input contacts manually in some embodiments. This system may provide incentives for a portion of the user's social network, up to and including the entire social network, to visit those locations participating in the program. Members of the user's social network who are also Groyalty members may be linked to the user in a Groyalty database or similar system for ease of delivering incentives. Other contacts who are not yet Groyalty members may be invited to join Groyalty. In some embodiments, a person need not be a member of Groyalty to receive such incentives, which may be directly emailed or otherwise delivered in the form of a standard coupon or similar.

In a new computer-implemented social-network loyalty-reward method, information that a user is engaging or has engaged in a transaction is received, additional information relating to the transaction is received, contact information for one or more people known by the user is determined at a computing device from the user's existing electronically stored contact information, and the sending of rewards to the one or more people known by the user is electronically initiated at the computing device in response to the user engaging in the transaction.

Registration information may also be received from the user and stored. Electronically initiating the sending of rewards may include sending rewards by text message, email, phone alert, app notification, or network posting. Determining contact information may include accessing the user's contact list on the user's mobile device or accessing the user's account on a social networking website. The additional information relating to the transaction may include transaction amount, products or services purchased, vendor, or location of transaction. A user's presence may also be detected at a point of sale during a transaction with a proximity detector. The proximity detector may communicate with the user's mobile device and detect that the user is registered with a loyalty-reward system. A user's presence at a point of sale during a transaction may be detected by reading information from a magnetic strip or other programmed card or bar-code, or from a keypad or other manual input. Loyalty rewards may be transmitted to the user's mobile device at a point of sale. Receiving additional information relating to the transaction may include receiving stored transaction information from the user's mobile device.

Additional information regarding the one or more people known by the user may also be received, and electronically initiating the sending of rewards to the one or more people known by the user may include using the additional information regarding the one or more people known by the user to select which of the one or more people to send the rewards to, or what rewards to send to the one or more people. A picture or sample audio recording may be taken at a point of sale to provide evidence that the user engaged in a transaction.

Vendor input may be used to set the type and amount of rewards sent. Vendor input received from a vendor may include information regarding how rewards should vary between times of day or year and between vendor locations, between users having different characteristics, and based on the number of users involved, and what circumstances trigger rewards to be sent. A user interface may be displayed to a vendor, and the user interface may be configured for a vendor to input rules governing rewards sent, and vendor-transmitted rules governing rewards sent may be received through the interface.

All rewards received by each person to which rewards are sent and whether the rewards received are used, and when they are used, and the circumstances under which the rewards are used may be tracked, and this information may be used in initiating the sending of rewards. The sending of rewards to the user may be initiated electronically at the computing device. The rewards sent may vary based on the number of users conducting a transaction in a single location within a certain time period or based on the number of locations a single user conducts transactions at within a given time period.

Methods may be carried out by a system of software modules. Such a system may include a contact information determination module, a reward determination and/or sending module, a proximity detection module, and an information receiving module. Such modules may for example reside on a remote server, be dispersed among several devices or reside in the cloud.

A computer-readable storage medium includes a program, which when executed on a processor performs an operation, the operation including receiving information that a user is engaging or has engaged in a transaction, receiving additional information relating to the transaction, determining contact information for one or more people known by the user from the user's existing electronically stored contact information, and electronically initiating the sending of rewards to the one or more people known by the user in response to the user engaging in the transaction.

A system includes a processor and a memory containing a program, which, when executed by the processor, is configured to perform an operation including receiving information that a user is engaging or has engaged in a transaction, receiving additional information relating to the transaction, determining contact information for one or more people known by the user from the user's existing electronically stored contact information, and electronically initiating the sending of rewards to the one or more people known by the user in response to the user engaging in the transaction.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a block diagram of a social network loyalty/reward system according to the present invention.

FIG. 2 is a flowchart of a mobile device resident application in a social network loyalty/reward system and method according to the present invention.

### DETAILED DESCRIPTION

A social network loyalty-reward system and method will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

A social network loyalty-reward system and method handles multiple vendor loyalty programs via a software application or program called “Groyalty.”

It will be understood that the diagrams in the Figures depicting the social network loyalty and reward system and method are exemplary only, and may be embodied in one or more dedicated electronic devices having a microprocessor, microcontroller, digital signal processor, application specific integrated circuit, field programmable gate array, any combination of the aforementioned devices, or other device that combines the functionality of the social network loyalty and reward system and method onto a single chip or multiple chips programmed to carry out the method steps described herein, or may be embodied in a general purpose computer having the appropriate peripherals attached thereto and software stored on a computer readable media that can be loaded into main memory and executed by a processing unit to carry out the functionality of the system and steps of the method described herein. Moreover, processing to accomplish the method steps may be distributed over a network of computing devices, including fixed and/or mobile computing devices.

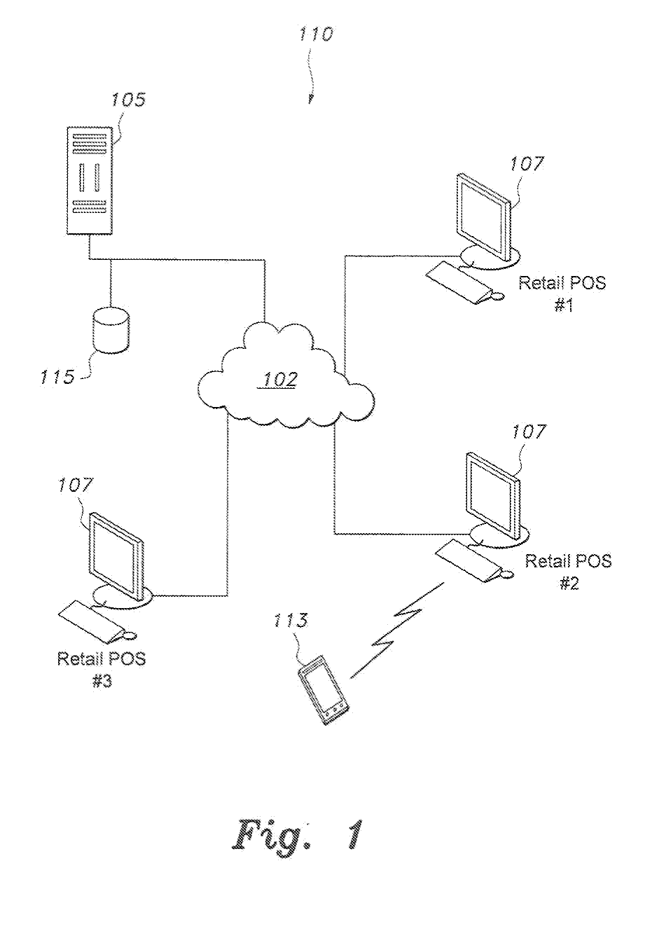

As shown in FIG. 1, the architecture of a social network loyalty rewards system 110 may include a plurality of retail point of sale devices (POS) 107 optionally connected to the Internet 102. Backend servers or a cloud computing system 105, in conjunction with a mass storage device containing a database 115, manage electronic loyalty coupon distribution to a user's Web-enabled mobile device 113. A client version of the Groyalty is loadable onto the customer's mobile device 113 and is configured to communicate and interact with Groyalty software running on server/system 105 via the internet 102. The system 110 in combination with a customer's mobile device 113 permits participation in a vendor's loyalty program via proximity to a specially designated location/device, to another mobile unit, or to a retailer's venue. The Groyalty application may work in conjunction with a proximity detector, so that the user's presence near a cash register, location, or other similar device, i.e., a point of sale (POS) 107 of a particular vendor, communicates with the user's mobile device to transmit a unique encrypted token signifying the user's loyalty with that particular vendor. The proximity detector is one way of automatically identifying when a Groyalty member is making a transaction without a need for any action on the part of the user. In some embodiments, a user may need to take some action, such as presenting an ID card or entering an ID code, to identify the user as a Groyalty member at the time of making the transaction. The client software installed on the mobile device 113 may record and store the user's transactions and transmit them to the server software, which may aggregate the transaction information with transaction information received from other Groyalty members.

A token representing loyalty points from a vendor is uploaded from the vendor device 107 into the user's mobile device 113, thereby obviating the requirement for a customer to produce a physical card or enter an “ID” number to receive the loyalty points. The mobile device 113 is presumed to include a contact list containing contact information of persons known to the user of the mobile device 113. The contact information can also include other web contact lists. The system 110 is specifically designed and arranged to utilize the user's social network, as defined by the user's contact list, and may provide rewards to those parties, as well as the user/customer. The system 110 provides incentives for the entire social network of participants, or a portion thereof, to visit those locations participating in the program. Locations participating in the program have chosen to be included in the application and to have incentives to visit the location be distributed via the application, and may pay a monthly or user/results-based or other subscription fee, and may install corresponding software and/or hardware such as a proximity sensor. Examples of incentives include discounts on some or all products, free products such as a free cup of coffee, keychain or mini flashlight with or without a certain purchase, privileged status (e.g. “Gold status”) for a limited or extended time, bonus points towards a proprietary loyalty or rewards system, upgrades, and the like. The incentives may be delivered electronically (as coupons or vouchers in the case of free products) or may be physically delivered to the recipients.

Such incentives may be delivered to a limited number or all of the user's contacts, or to a subset of contacts set by the user (for example the user may select ten contacts from the user's listed contacts to receive such rewards, either one time or on a transaction-by transaction or retailer-by-retailer basis). The user's contacts may be ranked by various criteria, such as interest in the particular purchase or retailer visited by the user (generated, for example, on the basis of keywords in the contact's social network profile, or on the results of a survey completed by the contact, or information supplied by a third party such as a credit card processor or other data aggregator) or closeness to the user, and incentives may be sent only to the top five or top ten contacts on the list, or to any other set number or percentage of ranked contacts. In some embodiments, a combination of methods may be used, for example if a user declines to select a number of contacts the application may make the selection automatically.

The system 110 may include a hardware and software combination that allows contact information of those within a given consumer's social network (as determined from, for example, the contacts stored on a user's mobile device) to be transmitted to the system 105 for purposes of providing those individuals with rewards from vendors.

A proximity detector may optionally be integrated into a retail POS device and may use wireless technology, such as WiFi, Bluetooth, GPS (“global positioning system”), or the like to determine the proximity of a user to a vendor device/location, for example by communicating with a user's mobile device. In some embodiments, the proximity detector may be integrated into a user's mobile device 113, which may use similar technology to detect the user's proximity to a vendor device/location. The vendor device/location may include an element such as a transmitter to assist in determining proximity thereto. The Groyalty app installed on a user's mobile device may have access (e.g. locally or remotely via server 105) to a list of participating vendor location/device GPS coordinates, and may detect proximity when a user's detected GPS coordinates are within a certain distance of one of the listed points. Alternatively, the Groyalty app may use Bluetooth, a short distance wireless communication standard, to query for proximate vendor locations/devices, which may have corresponding Bluetooth capabilities, or may be configured to receive and detect queries from the vendor locations/devices. When a vendor location/device is within range, proximity is detected. Any known proximity detection method can be substituted for those described herein, in various embodiments.

The Groyalty app may also take a picture or sample audio recording to provide evidence that the user visited the vendor location. The picture or audio recording may be of the user, to verify that the user was in possession of the mobile device at the time the mobile device was proximate the vendor device/location. Or, the picture or audio recording may be of the vendor device/location, for example it may be a picture of a barcode or other identifying graphic at the vendor location or on the vendor device. This picture or audio recording may work in conjunction with another proximity detector or may serve as a proximity detector in and of itself.

From a user's perspective, the loyalty programs of numerous vendors are managed by a single Groyalty application residing on the user's mobile device 113. The user/customer's presence and participation in the Groyalty program is determined by the presence of the user's mobile smartphone device 113 (such as a Droid or iPhone). The Groyalty service utilizes the user's “social network”, as defined by the user's smartphone's “contact list” or similar, and provides rewards to those parties in the user's social network, as well as to the user/customer him/herself. In some embodiments, a user's contact list is drawn from the user's mobile device contact list or social networking website account or in a known fashion, and the user then selects a subset of contacts from this list to receive incentives through the Groyalty program. In embodiments, contacts do not need to be members of Groyalty or even know about it to receive incentives. Incentives may be received by email or any other for of communication, for example an SMS text message may be sent to a mobile phone number contained in theuser's contact list. Incentive communications may also include a message encouraging a contact to sign up for Groyalty or explaining how to do so.

One example of the use of an embodiment of the present invention follows: A user goes to Store X and makes a purchase. By participating in the loyalty program either actively (providing a loyalty program card or ID) or passively (being detected automatically by e.g. a proximity sensor) a reward is sent to the user's closest friends. These friends may not know about Store X. They may never have been to Store X. However, they are likely to patronize Store X because of the user's proven affinity for it. A sample reward message is shown below:

“Your friend, Mark R., has just made a purchase at Store X! We trust that you will enjoy our products as well, and so we would like to welcome you to our store by offering you a FREE COFFEE just for stopping by.”

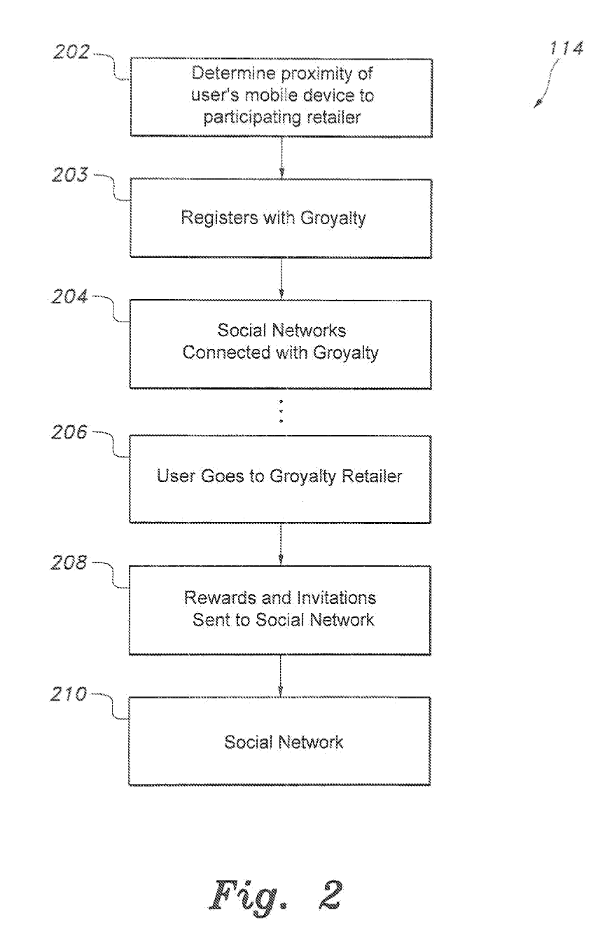

As shown in FIG. 2, a social network loyalty-reward method 114 may include a proximity determination step 202, a Groyalty registration step 203, a social network connection step 204, a user visitation with Groyalty retailer step 206, and a rewards and invitations sending step 208, whereby rewards and invitations are received at user's social network 210. Proximity determination step 202 and user visitation step 206 may involve GPS, Bluetooth®, picture, audio, and similar technologies. Passive systems for proximity determination include Shopkick®, in which the Point of Service (“POS”) machine emits an audio tone detected by smartphones but not humans, Bluetooth® sensors, and other types of automatic proximity sensors, which may be used to query nearby mobile devices to detect Groyalty members. In some embodiments, the proximity determination step may be carried out primarily by the user's mobile device, for example comparing the mobile device's GPS coordinates with a list of POS GPS coordinate locations. Some embodiments may use active systems for proximity determination, such as the user presenting a Groyalty card to a barcode or RFID scanner or typing a Groyalty ID into a POS typepad.

A user may first discover the system when entering the vicinity of a vendor participating in the program. For example, the vendor may have a POS device with a Bluetooth® transceiver, which detects a user's mobile device proximate to the POS device 202 and triggers the device to prompt the user to download the Groyalty app. Alternatively, the user may see signage at the POS device suggesting that the Groyalty app be downloaded, and download the app from an app store or from an internet website. The user, either before downloading the app or afterward, may register with Groyalty 203 by supplying information such as name, address, contact information, etc. and may create a corresponding user account. By registering, the user may be able to be recognized across multiple devices, for example a user can have a single account accessed from the user's phone, tablet, PDA (“personal digital assistant”), etc.

The user may then connect his or her social networks with the Groyalty app 204. For example, the user may give permission for the Groyalty app to access the user's contact information on the mobile device. Or, the app may be given access to the user's social networking account (e.g. Facebook, LinkedIn) and access and/or download contacts from those accounts. The user may then go to a participating Groyalty vendor 206 and be detected when proximate a certain location/device. In addition to receiving personal rewards and invitations via the Groyalty app, rewards and Invitations may also be sent via the Groyalty app to the user's social network 208 as identified by the app in step 204, and be received by the user's social network 210.

In some embodiments, the user may login to a website to run the Groyalty app. Instead of running a downloaded app directly from a device, the user may navigate to a website, login, and obtain the same functionality of being identified when in proximity to a vendor's location/device and receiving rewards directly and sending rewards to the user's social network. Similarly, the user may register via a website rather than through a downloadable app, and may discover the system online, through word of mouth, etc., rather than from being in the vicinity of a participating vendor. The system may also be extended to online purchases, recognizing that a user has navigated to a participating site and sending rewards or offers to the user and the user's social network.

System 110 in various embodiments is different in that it not only rewards a loyal repeat customer, but also rewards his/her social network, i.e., the contacts in the contact list of device 113, by providing them with incentives to also visit the same location or retailer. The system 110 and accompanying method in embodiments are designed to provide a reward to the user/customer's friends/contacts.

The system 110 and accompanying method in embodiments may also be designed to protect users' personally identifiable information. In traditional programs, a consumer has to fill out an application, providing detailed information, such as name, address, and telephone information. While the systems and methods disclosed herein may require some of this information, it is generally not passed on to the retailer/vendor.

The present system 110 and associated methods may require a user to purchase a product offered by a participating merchant in some embodiments. In other embodiments, a user is not required to purchase a product. In the case of an active system where users input an ID or scan an ID card during a transaction, the system can easily detect and record all details of transactions conducted by users, since each transaction is explicitly associated with a user. In the case of passive systems that automatically identify the presence of a user, the connection between user and transaction may not be made explicitly, for example if there are two users proximate to the retailer's POS device at the time of a transaction. This may be resolved by having a proximity detector with a very limited range, such that only a user actually making a purchase would be detected, or by an algorithm. For example, if at the time of a transaction some number of users is detected, and after the transaction one fewer user is detected, it may be assumed that the user who is no longer detected is associated with the most recent transaction (and left the area after their transaction was completed). Any type of technology implementation may be used to determine when a user makes a purchase or other transaction, and such implementations may also use for example biometrics or RFID or other near-field communication.

Moreover, the system 110 may prompt a participating vendor to present a specialty reward (e.g. free coffee) to either all or a portion of those in the user's social network who have never received a previous reward associated with the location. If the contacts in the user's social network are also system users (e.g. Groyalty members) the system may track all the incentives they receive and use. If not, the system may keep a record of incentives received and/or used by email address or other identifying information. It is also contemplated that either all or a portion of those in the user's social network who have previously received a reward associated with the location or retailer may be presented with a fraction of a reward (e.g., 1 of 10 toward a free coffee).

A user who has never previously visited a particular location or participating vendor may be presented with a special reward (e.g., free coffee), as prompted by the system 110. Additionally, the system 110 may prompt a merchant to allow a user who has visited a particular location or participating retailer previously to be provided with a fraction of a reward (e.g., 2 of 10 towards a free coffee). In either case, the reward may be provided, for example, after the user makes a purchase, or after the user is first detected at the location. Whether the reward is triggered by the user's presence or purchase, or something else, may be determined in some embodiments by the vendor. In some embodiments, tiered rewards may be offered for different triggering actions—for example, a single reward for visiting the location and a double reward for an actual transaction. Such rewards may similarly be sent to the user's contacts after the user's presence or transaction is detected.

Multiple connected members of a social network who visit a particular location, a set of predefined locations, or a participating vendor within a given time period (e.g., 30 minutes) may receive a bonus reward (e.g., 4 of 10 towards a free coffee). In another exemplary scenario, customer/users who have formed a book club and meet at a coffee shop receive double credit (double rewards points, or two free items, etc.). In some embodiments, vendors have detailed control over the specifics of what rewards are offered and when. Vendors may have online or downloaded interfaces they can use to set the rewards users received and the triggering events that result in the rewards being sent. Any number of variations are possible, for example vendors may provide rewards based on monthly (or weekly, yearly, etc.) transaction volume, frequency, or average ticket, the number of the user's contacts who visit the vendor, the time of day, month or year that a visit or transaction takes place, the geographic location of the vendor visited, etc. In some embodiments, vendors may even be able to create manual rewards specifically targeted to individual users or groups of users (e.g. a book club, or church group, sports team, etc.) or specific times (sporting events, holidays, etc.).

The system 110 can also be set up so that when a user or multiple connected members of a social network visit a set of predefined locations or participating retailers (or combination thereof) in a predefined order within a time period, they receive a special reward (e.g., a gift from an online retailer).

In some embodiments of the system 110, the location of a user may be determined by GPS using the user's mobile device 113. Alternatively, location is determined by near-range wireless technology (e.g., Wi-Fi or Bluetooth) or similar. Some embodiments may employ a method wherein location is determined by the user taking a picture using the mobile device 113 (e.g., picture of a bar code or storefront). Yet, in other embodiments of the system 110, location is determined by the user entering a code (or token) presented by someone, e.g., retail staff, at the location, wherein the option of also capturing audio may be provided.

It is to be understood that the present invention is not limited to the embodiments described above, but encompasses any and all embodiments within the scope of the following claims.

The invention is not limited to the particular embodiments illustrated in the drawings and described above in detail. Those skilled in the art will recognize that other arrangements could be devised, for example, using various mobile devices such as tablets and laptops, various location-sensing technologies, various types of loyalty rewards-providing organizations, and various back-end and network architecture and vendor equipment. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

I claim:

1. A computer-implemented social-network loyalty-reward method, comprising:
receiving information that a user is engaging or has engaged in a transaction;
receiving additional information relating to the transaction;
determining, at a computing device, contact information for one or more people known by the user from the user's existing electronically stored contact information; and
electronically initiating, at the computing device, the sending of rewards to the one or more people known by the user in response to the user engaging in the transaction.

2. The method of claim 1, further comprising receiving and storing registration information from the user.

3. The method of claim 1, wherein electronically initiating the sending of rewards comprises sending rewards by text message, email, phone alert, app notification, or network posting.

4. The method of claim 1, wherein determining contact information comprises accessing the user's contact list on the user's mobile device.

5. The method of claim 1, wherein determining contact information comprises accessing the user's account on a social networking website.

6. The method of claim 1, wherein the additional information relating to the transaction comprises transaction amount, products or services purchased, vendor, or location of transaction.

7. The method of claim 1, further comprising detecting a user's presence at a point of sale during a transaction with a proximity detector.

8. The method of claim 7, wherein the proximity detector communicates with the user's mobile device and detects that the user is registered with a loyalty-reward system.

9. The method of claim 1, further comprising detecting a user's presence at a point of sale during a transaction by reading information from a magnetic strip or other programmed card or bar-code, or from a keypad or other manual input.

10. The method of claim 1, further comprising transmitting loyalty rewards to the user's mobile device at a point of sale.

11. The method of claim 1, wherein receiving additional information relating to the transaction comprises receiving stored transaction information from the user's mobile device.

12. The method of claim 1, further comprising receiving additional information regarding the one or more people known by the user, wherein electronically initiating the sending of rewards to the one or more people known by the user comprises using the additional information regarding the one or more people known by the user to select which of the one or more people to send the rewards to, or what rewards to send to the one or more people.

13. The method of claim 1, further comprising taking a picture or sample audio recording at a point of sale to provide evidence that the user engaged in a transaction.

14. The method of claim 1, wherein vendor input is used to set the type and amount of rewards sent.

15. The method of claim 14, wherein vendor input received from a vendor comprises information regarding how rewards should vary between times of day or year and between vendor locations, between users having different characteristics, and based on the number of users involved, and what circumstances trigger rewards to be sent.

16. The method of claim 14, further comprising displaying a user interface to a vendor, wherein the user interface is configured for a vendor to input rules governing rewards sent, and receiving through the interface vendor-transmitted rules governing rewards sent.

17. The method of claim 1, further comprising tracking all rewards received by each person to which rewards are sent and whether the rewards received are used, and when they are used, the circumstances under which the rewards are used, and using this information in initiating the sending of rewards.

18. The method of claim 1, further comprising electronically initiating, at the computing device, the sending of rewards to the user.

19. A computer-readable storage medium including a program, which when executed on a processor performs an operation, the operation comprising:
receiving information that a user is engaging or has engaged in a transaction;
receiving additional information relating to the transaction;
determining contact information for one or more people known by the user from the user's existing electronically stored contact information; and
electronically initiating the sending of rewards to the one or more people known by the user in response to the user engaging in the transaction.

20. A system, comprising:
a processor; and
a memory containing a program, which, when executed by the processor, is configured to perform an operation, the operation comprising:
receiving information that a user is engaging or has engaged in a transaction;
receiving additional information relating to the transaction;
determining contact information for one or more people known by the user from the user's existing electronically stored contact information; and
electronically initiating the sending of rewards to the one or more people known by the user in response to the user engaging in the transaction.

21. The method of claim 1, wherein the rewards sent vary based on the number of users conducting a transaction in a single location within a certain time period or based on the number of locations a single user conducts transactions at within a given time period.
